(19) United States
(12) Patent Application Publication
(10) Pub. No.: US 2024/0212219 A1
(43) Pub. Date: Jun. 27, 2024

(54) POINT CLOUD DECODING DEVICE, POINT CLOUD DECODING METHOD, AND PROGRAM

(71) Applicant: KDDI CORPORATION, Tokyo (JP)

(72) Inventors: Kouhei MATSUZAKI, Fujimino-shi (JP); Kei KAWAMURA, Fujimino-shi (JP); Kyohei UNNO, Fujimino-shi (JP)

(73) Assignee: KDDI CORPORATION, Tokyo (JP)

(21) Appl. No.: 18/594,466

(22) Filed: Mar. 4, 2024

Related U.S. Application Data
(63) Continuation of application No. PCT/JP2022/042341, filed on Nov. 15, 2022.

(30) Foreign Application Priority Data
Nov. 25, 2021 (JP) 2021-190773

(51) Int. Cl. G06T 9/00; G06T 9/40

(52) U.S. Cl. CPC G06T 9/001; G06T 9/40

(57) ABSTRACT

A point cloud decoding device (200) according to the present invention including a circuit, wherein the circuit: stores occupancy information of a child hierarchical node indicating whether or not the child hierarchical node is occupied; and predicts occupancy information of a child node indicating whether or not the child node is occupied using the occupancy information of the child hierarchical node.

### CROSS-REFERENCE TO RELATED APPLICATIONS

The present application is a continuation of PCT Application No. PCT/JP2022/042341, filed on Nov. 15, 2022, which claims the benefit of Japanese patent application No. 2021-190773 filed on Nov. 25, 2021, the entire contents of which are incorporated herein by reference in its entirety.

### TECHNICAL FIELD

The present invention relates to a point cloud decoding device, a point cloud decoding method, and a program.

### BACKGROUND ART

For example, a point cloud encoding and decoding technology based on an octree method as in Non patent Literature 1 is widely used.

In the octree method used in such a technology, a three-dimensional space is divided into finite spaces called nodes. Then, a process of dividing each node into eight nodes is performed hierarchically.

In such a process, a currently focused-on node before division called a parent node, and a node after division is referred to as a child node. In addition, another node in the same hierarchy as the parent node is called a parent hierarchical node, and another node in the same hierarchy as the child node is called a child hierarchical node.

Non patent Literature 2 discloses an intra prediction method for predicting occupancy states of eight child nodes by referring to occupancy states of 26 parent hierarchical nodes that share a plane, a side, or a vertex with a parent node in the octree method.

In such a technology, an occupancy score is calculated for each of the eight child nodes using a value obtained by multiplying occupancy states of the 26 parent hierarchical nodes and a weight parameter set in advance. Then, by using two threshold values th0 and th1, it is determined that the child node is unoccupied when the occupancy score is equal to or smaller than th0, it is determined that the child node is occupied when the occupancy score is equal to or larger than th1, and it is determined that the child node is unpredictable when the occupancy score is larger than th0 and smaller than th1.

Non patent Literature 3 discloses a technology of reducing the number of parent hierarchical nodes referred to for each of the eight child nodes to seven, thereby reducing the time required for encoding and decoding processing as compared with that in the technology of Non patent Literature 2.

### CITATION LIST

### Non Patent Literature

Non patent Literature 1: G-PCC codec description v5, ISO/IEC JTC1/SC29/WG11 N18891
Non patent Literature 2: [PCC] Intra mode for geometry coding in TMC3, ISO/IEC JTC1/SC29/WG11 MPEG2018/m43600
Non patent Literature 3: [G-PCC] [new proposal] On geometry occupancy intra prediction, ISO/IEC JTC1/SC29/WG11 MPEG2020/m52327

### SUMMARY OF THE INVENTION

However, the intra prediction of Non patent Literature 2 and Non patent Literature 3 has a problem that while there is a compression performance improving effect for a dense point cloud, there is no effect for a sparse point cloud as measured by LiDAR.

Therefore, the present invention has been made in view of the above-described problem, and an object of the present invention is to provide a point cloud decoding device, a point cloud decoding method, and a program capable of improving accuracy of intra prediction with respect to a point cloud and improving compression performance.

A first aspect of the present invention is summarized as a point cloud decoding device configured to decode a point cloud from a bit stream, the point cloud decoding device including a circuit, wherein the circuit: stores occupancy information of a child hierarchical node indicating whether or not the child hierarchical node is occupied; and predicts occupancy information of a child node indicating whether or not the child node is occupied using the occupancy information of the child hierarchical node.

A second aspect of the present invention is summarized as a point cloud decoding method for decoding a point cloud from a bit stream, the point cloud decoding method including: storing occupancy information of a child hierarchical node indicating whether or not the child hierarchical node is occupied; and predicting occupancy information of a child node indicating whether or not the child node is occupied using the occupancy information of the child hierarchical node.

A third aspect of the present invention is summarized as a program stored on a non-transitory computer-readable medium for causing a computer to function as a point cloud decoding device configured to decode a point cloud from a bit stream, the point cloud decoding device including a circuit, wherein the circuit: stores occupancy information of a child hierarchical node indicating whether or not the child hierarchical node is occupied; and predicts occupancy information of a child node indicating whether or not the child node is occupied using the occupancy information of the child hierarchical node.

According to the present invention, it is possible to provide a point cloud decoding device, a point cloud decoding method, and a program capable of improving accuracy of intra prediction with respect to a point cloud and improving compression performance.

### BRIEF DESCRIPTION OF THE DRAWINGS

FIG. 1 is a diagram illustrating an example of a configuration of a point cloud processing system 10 according to an embodiment.

FIG. 2 is a diagram illustrating an example of functional blocks of a point cloud decoding device 200 according to an embodiment.

FIG. 3 is a diagram for explaining an example of prediction by an intra prediction unit 21 of the point cloud decoding device 200 according to an embodiment.

FIG. 4 is a diagram for explaining an example of prediction by the intra prediction unit 21 of the point cloud decoding device 200 according to an embodiment.

FIG. 5A is a diagram for explaining an example of prediction by the intra prediction unit 21 of the point cloud decoding device 200 according to an embodiment.

FIG. 5B is a diagram for explaining an example of prediction by the intra prediction unit 21 of the point cloud decoding device 200 according to an embodiment.

FIG. 6 is a diagram for explaining an example of prediction by the intra prediction unit 21 of the point cloud decoding device 200 according to an embodiment.

FIG. 7 is a diagram for explaining an example of prediction by the intra prediction unit 21 of the point cloud decoding device 200 according to an embodiment.

### DESCRIPTION OF EMBODIMENTS

An embodiment of the present invention will be explained hereinbelow with reference to the drawings. Note that the constituent elements of the embodiment below can, where appropriate, be substituted with existing constituent elements and the like, and that a wide range of variations, including combinations with other existing constituent elements, is possible. Therefore, there are no limitations placed on the content of the invention as in the claims on the basis of the disclosures of the embodiment hereinbelow.

### First Embodiment

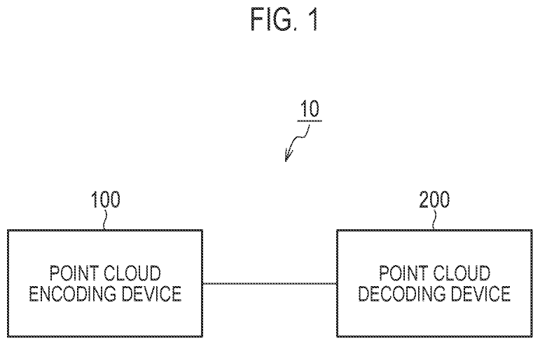

Hereinafter, a point cloud processing system 10 according to a first embodiment of the present invention will be described with reference to FIGS. 1 to 7. FIG. 1 is a diagram illustrating a point cloud processing system 10 according to the present embodiment.

As illustrated in FIG. 1, the point cloud processing system 10 includes a point cloud encoding device 100 and a point cloud decoding device 200.

The point cloud encoding device 100 is configured to generate encoded data (a bit stream) by encoding an input point cloud signal. The point cloud decoding device 200 is configured to generate an output point cloud signal by decoding the bit stream.

Note that the input point cloud signal and the output point cloud signal include position information and attribute information for each point in the point cloud. The attribute information is, for example, color information or a reflectance for each point.

Here, such a bit stream may be transmitted from the point cloud encoding device 100 to the point cloud decoding device 200 via a transmission path.

Furthermore, the bit stream may be provided from the point cloud encoding device 100 to the point cloud decoding device 200 after being stored in a storage medium.

### Point Cloud Decoding Device 200

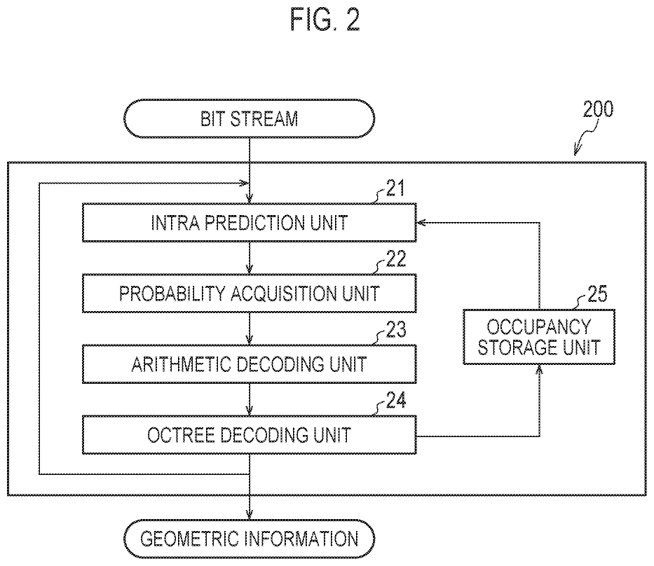

Hereinafter, the point cloud decoding device 200 according to the present embodiment will be described with reference to FIG. 2. FIG. 2 is a diagram illustrating an example of functional blocks of the point cloud decoding device 200 according to the present embodiment.

As illustrated in FIG. 2, the point cloud decoding device 200 includes an intra prediction unit 21, a probability acquisition unit 22, an arithmetic decoding unit 23, an octree decoding unit 24, and an occupancy storage unit 25. These functional blocks are realized by executing a program that causes a computer mounted on the point cloud decoding device 200 to function.

Hereinafter, each functional block of the point cloud decoding device 200 according to the present embodiment will be described. As specific processing in the probability acquisition unit 22, the arithmetic decoding unit 23, and the octree decoding unit 24, for example, the method described in Non patent Literature 1 mentioned above can be used.

### [Intra Prediction Unit 21]

The intra prediction unit 21 is configured to predict occupancy states of eight child nodes obtained by dividing a parent node.

Here, an occupancy state of a child node is information indicating whether or not the child node is occupied, that is, whether or not a point exists in the child node. Note that when a point exists in a child node, the child node is occupied.

In the present embodiment, the intra prediction unit 21 is configured to predict an occupancy state of a child node using a scanning range and a scanning interval in a LiDAR sensor.

The LiDAR sensor measures a distance to an object using a laser beam, and expresses a position of the measured object as a point.

Generally, the distance to the surrounding object can be scanned by changing an irradiation direction of the laser beam in a horizontal direction or in a vertical direction. The scanning range and the scanning interval in the horizontal direction or in the vertical direction are determined for each piece of hardware.

In an example, the scanning range and the scanning interval in the horizontal direction of the Velodyne HDL-64E LiDAR sensor are, 360° and 0.08°, respectively, and the scanning range and the scanning interval in the vertical direction of the Velodyne HDL-64E LiDAR are 26.9° and 0.4°, respectively.

The intra prediction unit 21 is configured to predict an occupancy state of a child node using such a scanning range or scanning interval.

Here, the information on the scanning range and the scanning interval may be held in the point cloud decoding device 200 in advance, or may be included in the input bit stream.

Furthermore, in a case where temporally consecutive point clouds are decoded, the intra prediction unit 21 may be configured to estimate a scanning range and a scanning interval using one or more previously-decoded point clouds.

That is, the intra prediction unit 21 may be configured to obtain an azimuth angle and a polar angle by converting coordinates of the decoded point cloud from an orthogonal coordinate system to a polar coordinate system, and estimate a scanning range from the maximum value and the minimum value of the azimuth angle and the polar angle.

Furthermore, the intra prediction unit 21 may be configured to search for the nearest point for each point with respect to the azimuth angle direction and the polar angle direction, obtain an absolute value of a difference between the azimuth angle and the polar angle of the nearest point, and use an average value or a median value thereof as a scan interval estimation result.

Here, the intra prediction unit 21 may be configured to first estimate a scanning interval in the vertical direction, divide the point cloud for each scanning interval by using a value of the estimated scanning interval, and then estimate a scanning interval in the horizontal direction by using the divided point cloud.

Alternatively, the intra prediction unit 21 may be configured to first estimate a scanning interval in the horizontal direction, divide the point cloud for each scanning interval by using a value of the estimated scanning interval, and then estimate a scanning interval in the vertical direction by using the divided point cloud.

Note that an occupancy state of a child hierarchical node or a parent hierarchical node and a position of an occupied child hierarchical node to be used in the following description are given from the occupancy storage unit 25.

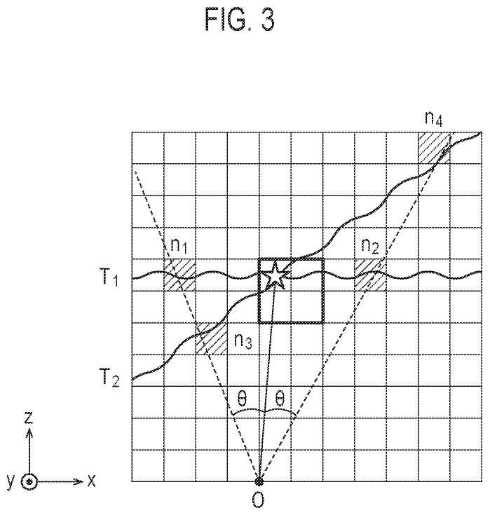

An outline of prediction by the intra prediction unit 21 will be described with reference to FIG. 3.

In the example of FIG. 3, for simplification, child hierarchical nodes viewed from above in the vertical direction are represented by quadrangles in consideration of only the horizontal direction. The shaded squares represent occupied child hierarchical nodes, and the white squares represent unoccupied child hierarchical nodes.

In addition, a quadrangle represented by a black thick line represents a parent node, and a black circle represents a position of a LiDAR sensor. The position of the LiDAR sensor corresponds to an origin O of a local coordinate system for indicating a point.

Here, a quadrangle including a star-shaped symbol is defined as a child node for which an occupancy state is will be predicted from now (a prediction-target child node).

If the scanning interval in the horizontal direction is θ, in a case where the prediction-target child node is occupied, it is considered that any child hierarchical node spaced away from the center of the prediction-target child node by θ in the horizontal direction is occupied.

However, a position of a child hierarchical node to be occupied varies depending on a shape of an object surface. For example, in a case where a wavy line denoted by T1 represents a surface of an object, child hierarchical nodes denoted by n1 and n2 are occupied. On the other hand, when a wavy line denoted by T2 represents the object surface, child hierarchical nodes denoted by n3 and n4 are occupied.

Therefore, when any child hierarchical node located on a path of a laser beam represented by a dotted line is occupied, the intra prediction unit 21 may predict that the prediction-target child node is occupied.

Furthermore, in consideration of a measurement error, in a case where a child hierarchical node located on a path of a laser beam passing through an azimuth obtained by adding a minute change to θ is occupied, the intra prediction unit 21 may predict that the prediction-target child node is occupied.

However, an amount of calculation in the process of referring to occupancy states of all the child hierarchical nodes located on the path of the laser beam is large. Therefore, the intra prediction unit 21 may limit child hierarchical nodes to be referred to by any method, for example, by referring only to child hierarchical nodes spaced away from the prediction-target child node within a threshold distance.

Furthermore, the intra prediction unit 21 may not refer to child hierarchical nodes located outside the scanning range of the LiDAR sensor.

Alternatively, the intra prediction unit 21 may estimate positions of the child hierarchical nodes to be referred to by any method. For example, the intra prediction unit 21 may estimate positions of child hierarchical nodes of which the azimuth angles are away from the azimuth angle of the center of the prediction-target child node by θ by linear regression using the positions of the occupied child hierarchical nodes of which the azimuth angles are away from the azimuth angle of the center of the prediction-target child node by 3θ and 2θ, or by another method.

At this time, the intra prediction unit 21 may use the positions of the occupied child hierarchical nodes given from the occupancy storage unit 25, or may newly calculate the positions of the occupied child hierarchical nodes.

Furthermore, in consideration of a measurement error, the intra prediction unit 21 may refer to child hierarchical nodes around the estimated position, and predict that the prediction-target child node is occupied when any of the referred-to child hierarchical nodes is occupied.

Further, the intra prediction unit 21 may perform a prediction in the vertical direction in a similar manner. In a case where predictions are independently performed on the same child node in the horizontal direction and in the vertical direction, the intra prediction unit 21 may predict that the prediction-target child node is occupied if it is predicted that the prediction-target child node is occupied in either one of the horizontal direction and the vertical direction, or may predict that the prediction-target child node is occupied only when it is predicted that the prediction-target child node is occupied in both of the horizontal direction and the vertical direction.

Note that the child hierarchical nodes to be referred to are not always decoded. Therefore, the intra prediction unit 21 may regard an occupancy state of a child hierarchical node that has not yet been decoded as unoccupied.

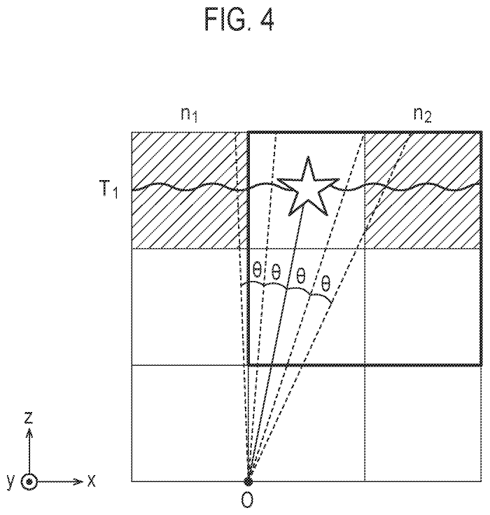

Furthermore, concerning the prediction by the intra prediction unit 21, as illustrated in FIG. 4, a laser beam spaced apart by θ from the center of the child node including the star-shaped symbol may pass through the inside of the prediction-target child node.

At this time, for example, in a case where a wavy line denoted by T1 represents a surface of an object, child hierarchical nodes denoted by n1 and n2 are occupied. However, since the laser beam spaced away from the center of the child node by θ passes through neither n1 nor n2, the intra prediction unit 21 cannot predict that the prediction-target child node is occupied.

In such a case, when a child hierarchical node located on the path of the laser beam spaced apart by N×θ near the prediction-target child node is occupied, the intra prediction unit 21 may predict that the prediction-target child node is occupied.

Here, N is any natural number. N may be a minimum value at which the laser beam does not pass through the inside of the prediction-target child node, or may be another value. Furthermore, N used for prediction in the intra prediction unit 21 may be one or more.

In the example of FIG. 4, in the case of N=2, since the laser beam passes through n1, the intra prediction unit 21 can predict that the prediction-target child node is occupied.

Here, the intra prediction unit 21 may perform coordinate conversion on the coordinates of the center of the prediction-target child node using the angle θ in order to determine whether or not the laser beam spaced away by θ from the center of the prediction-target child node passes through the inside of the prediction-target child node, and determine whether or not the obtained coordinates are located inside the prediction-target child node.

Alternatively, the intra prediction unit 21 may make a determination using an approximate expression by which it is considered that the coordinates are located inside the prediction-target child node, such as l×tanθ<r/2 where r is a length of one side of the prediction-target child node and l is a distance from the origin to the center of the prediction-target child node.

In addition, since the values of θ and r can be determined before encoding and decoding are executed, determination results for coordinates indicating the position of child node may be calculated in advance and stored in a lookup table.

Then, the intra prediction unit 21 may omit a calculation required for determination by referring to the determination result from the coordinates of the child node using such a lookup table at the time of performing encoding or decoding.

When the determination results for all the nodes match in each hierarchy in the octree method, the intra prediction unit 21 may omit such determination processing. Similarly, minimum N at which the laser beam does not pass through the inside of the prediction-target child node may be calculated and stored in advance.

In the present embodiment, in order to speed up prediction processing, the intra prediction unit 21 may be configured to predict an occupancy state of the prediction-target child node by a method in which the above-described processing is simplified by limiting the range in which child hierarchical nodes are referred to only to the vicinity of the child node.

That is, the intra prediction unit 21 may be configured to predict a child node near which an occupied child hierarchical node exists to be occupied.

For example, the intra prediction unit 21 may be configured to predict a child node that shares a plane, a side, or a vertex with an occupied child hierarchical node to be occupied.

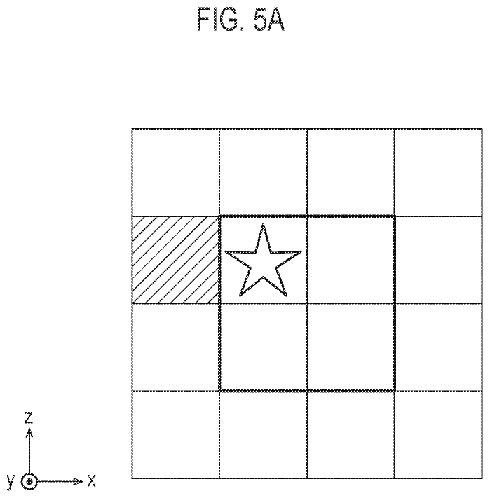

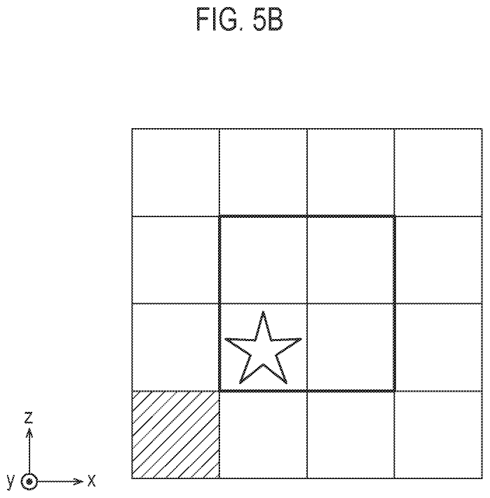

An example of prediction by the intra prediction unit 21 will be described using expressions similar to those in FIG. 3 with reference to FIGS. 5A and 5B.

FIG. 5A illustrates an example of a prediction-target child node that shares a plane with an occupied child hierarchical node. Since the child hierarchical node that shares a plane with the prediction-target child node including a star-shaped symbol is occupied, the intra prediction unit 21 predicts that the prediction-target child node is occupied.

FIG. 5B illustrates an example of a prediction-target child node that shares a side with an occupied child hierarchical node. Since the child hierarchical node that shares the side with the prediction-target child node including a star-shaped symbol is occupied, the intra prediction unit 21 predicts that the prediction-target child node is occupied.

Note that, although an example of a prediction-target child node that shares a vertex with an occupied child hierarchical node, the intra prediction unit 21 can perform a prediction in a similar manner.

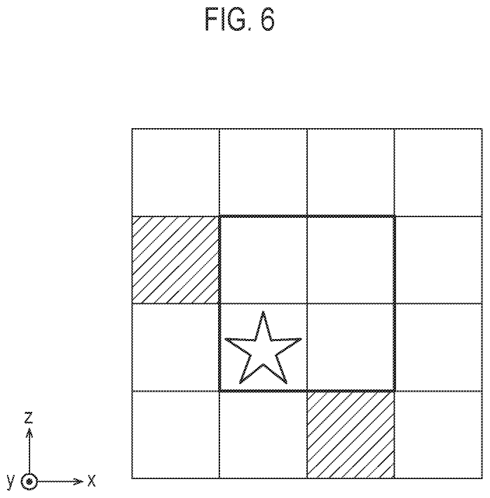

Furthermore, as illustrated in FIG. 6, the intra prediction unit 21 may be configured to predict that a prediction-target child node is occupied only when the prediction-target child node shares a plane, a side, or a vertex with a plurality of child hierarchical nodes predicted to be occupied.

Note that the intra prediction unit 21 does not necessarily refer to all the child hierarchical nodes existing near the prediction-target child node (for example, at positions sharing a plane, a side, or a vertex with the prediction-target child node), and may be configured to refer to only some selected child hierarchical nodes.

For example, the intra prediction unit 21 may be configured to select a child hierarchical node having compression performance improved in a high degree by encoding point cloud data for training using such prediction, by comparing compression performance in a case where each child hierarchical node expressed as a relative position with respect to the position of the prediction-target child node is selected with compression performance in a case where the same is not selected, or by using another method.

Further, intra prediction unit 21 may be configured to cumulatively add an occupancy score to the prediction-target child node by using an occupancy state of a child hierarchical node to be referred to, rather than predicting that the prediction-target child node is occupied when any of the child hierarchical nodes to be referred to is occupied.

The occupancy score is a value obtained by multiplying a weight by a binary value that is “1” when the child hierarchical node to be referred to is occupied and “0” when the child hierarchical node to be referred to is not occupied.

Here, for example, different weights may be used between a case where the child hierarchical node to be referred to shares a plane with the prediction-target child node, a case where the child hierarchical node to be referred to shares a side with the prediction-target child node, and a case where the child hierarchical node to be referred to shares a vertex with the prediction-target child node.

In addition, the intra prediction unit 21 may be configured to divide the final occupancy score by the number of times an occupancy score is added to the prediction-target child node. Then, by using two threshold values th0 and th1, the intra prediction unit 21 may be configured to determine that the prediction-target child node is unoccupied when the occupancy score is equal to or smaller than th0, determine that the prediction-target child node is occupied when the occupancy score is equal to or larger than th1, and determine that the prediction-target child node is unpredictable when the occupancy score is larger than th0 and smaller than th1.

In addition, since the child hierarchical nodes to be referred to are not always decoded, information necessary for prediction may be insufficient. In order to compensate for such insufficient information, the intra prediction unit 21 may be configured to perform a prediction using a parent hierarchical node.

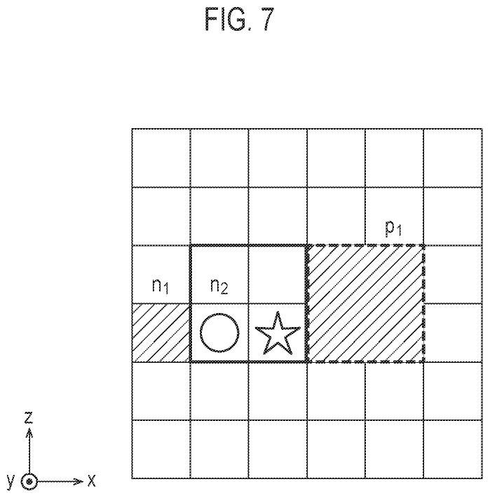

An example of such a prediction will be described with reference to FIG. 7. In the example of FIG. 7, for simplification, child hierarchical nodes viewed from above in the vertical direction are represented by quadrangles in consideration of only the horizontal direction. The shaded squares represent occupied child hierarchical nodes, and the white squares represent unoccupied child hierarchical nodes.

In addition, a quadrangle represented by a black thick line represents a parent node, and a quadrangle represented by a black thick dotted line represents a parent hierarchical node.

In the example of FIG. 7, it is assumed that both a child hierarchical node denoted by n1 and a parent hierarchical node denoted by p1 are occupied. A child hierarchical node included in p1 has not yet been decoded, and an occupancy state of the child hierarchical node is unknown.

A child node denoted by n2 is predicted to be occupied because it shares a plane with n1. Note that a node predicted to be occupied is expressed as including a round symbol.

Here, it is assumed to predict an occupancy state of a child node including a star-shaped symbol. In the present embodiment, assuming that a point cloud represents a continuous surface of an object, the intra prediction unit 21 predicts that a child node located between a child node predicted to be occupied and an occupied parent hierarchical node is occupied.

Note that, in FIG. 7, in a case where n2 is predicted to be unoccupied or in a case where p1 is unoccupied, the intra prediction unit 21 predicts that the child node including the star-shaped symbol is unoccupied.

In this way, the intra prediction unit 21 is configured to perform a prediction using a parent hierarchical node. Furthermore, the intra prediction unit 21 may be configured to perform a prediction in the vertical direction in a similar manner.

In a case where predictions are independently performed on the same prediction-target child node in the horizontal direction and in the vertical direction, the intra prediction unit 21 may predict that the prediction-target child node is occupied if it is predicted that the prediction-target child node is occupied in either one of the horizontal direction and the vertical direction, or may predict that the prediction-target child node is occupied only when it is predicted that the prediction-target child node is occupied in both of the horizontal direction and the vertical direction.

Note that the intra prediction unit 21 is not necessarily required to perform such predictions for all possible combinations of positional relationships between child nodes and parent hierarchical nodes, and may be configured to perform such predictions only for some selected combinations.

Here, the intra prediction unit 21 may select a child hierarchical node having compression performance improved in a high degree by encoding point cloud data for training using the above-described prediction, by comparing compression performance in a case where each combination is selected with compression performance in a case where each combination is not selected, or by using another method.

Note that the intra prediction unit 21 may be configured to cumulatively add an occupancy score to the prediction-target child node, and predict an occupancy state of the prediction-target child node by threshold determination, similarly to the method described above.

Here, the intra prediction unit 21 sets, as an occupancy score, a value obtained by multiplying a weight by a binary value that is “1” when the prediction-target child node is located between a child node predicted to be occupied and an occupied parent hierarchical node in an assumed combination and is otherwise “0”.

Such an occupancy score may be common to an occupancy score in a case where a prediction is performed using only child hierarchical nodes. Here, different weights may be used between a case where only child hierarchical nodes are used and a case where a parent hierarchical node is used.

### [Probability Acquisition Unit 22]

The probability acquisition unit 22 is configured to acquire an occurrence probability of data corresponding to a node decoded by the arithmetic decoding unit 23 occurs, using the prediction of occupancy information given from the intra prediction unit 21. The occurrence probability may be a fixed value or an adaptively variable value.

When acquiring the occurrence probability, the probability acquisition unit 22 may use other information such as occupancy information of neighboring nodes of the parent node corresponding to the child node decoded by the arithmetic decoding unit 23 or occupancy information of eight child nodes having a common parent node.

The probability acquisition unit 22 is configured to output the acquired occurrence probability to the arithmetic decoding unit 23.

### [Arithmetic Decoding Unit 23]

The arithmetic decoding unit 23 is configured to decode octree data (bit string) using the input bit stream and the occurrence probability given by the probability acquisition unit 22.

Such octree data may be a binary value of 0 or 1, or may be other values.

Note that, in the present embodiment, in all or some of the parent nodes, the octree data may be replaced with known quad tree data or binary tree data.

### [Octree Decoding Unit 24]

The octree decoding unit 24 is configured to decode geometric information from the bit string using a decoding technique based on a known octree method.

That is, in a case where eight bits indicating occupancy information of eight child nodes included in a certain parent node are given, the octree decoding unit 24 is configured to generate child nodes at positions where the bits are “1”.

The octree decoding unit 24 is configured to perform such processing hierarchically from an upper hierarchy to a lower hierarchy and output coordinates of a node of the lowermost hierarchy as geometric information indicating a point cloud.

In the present embodiment, in all or some of the parent nodes, the octree method may be replaced with a known quad tree method or binary tree method.

In addition, the octree decoding unit 24 may be configured to decode parent nodes in ascending order of the azimuth angle so that child hierarchical nodes positioned with smaller azimuth angles with respect to the parent node are always decoded.

Similarly, the octree decoding unit 24 may be configured to decode parent nodes in ascending order of polar angle.

### [Occupancy Storage Unit 25]

The occupancy storage unit 25 is configured to store an occupancy state of a child node for each hierarchy by using the position information of the occupied child node given from the octree decoding unit 24.

The occupancy storage unit 25 may be configured to store an occupancy state of a child hierarchical node positioned near each occupied child node for use by the intra prediction unit 21.

Note that, in the octree method, a child hierarchical node of a current hierarchy can be regarded as a parent hierarchical node of a hierarchy that is one level deeper than the current hierarchy.

In addition, the occupancy storage unit 25 divides a scanning range of the LiDAR sensor in the horizontal direction and/or the vertical direction in advance. The occupancy storage unit 25 may be configured to store coordinates of child hierarchical nodes located within each divided range.

Such information may be used to estimate a position of a child hierarchical node to be referred to by the intra prediction unit 21.

According to the present embodiment, it is possible to predict occupancy states of eight child nodes corresponding to a parent node from an occupancy state of a child hierarchical node on the basis of the estimation of the position of the point cloud measured by the LiDAR sensor or the like, and it is possible to improve the accuracy of the intra prediction of the point cloud and improve the compression performance.

Note that the above described embodiments have been described by taking application of the present invention to the point cloud encoding device 100 and the point cloud decoding device 200 as examples. However, the present invention is not limited only thereto, but can be similarly applied to an encoding/decoding system having functions of the encoding device 100 and the decoding device 200.

According to the present embodiment, it is possible to improve the overall quality of service in video communications, thereby contributing to Goal 9 of the UN-led Sustainable Development Goals (SDGs) which is to “build resilient infrastructure, promote inclusive and sustainable industrialization and foster innovation”.

What is claimed is:

1. A point cloud decoding device configured to decode a point cloud from a bit stream, the point cloud decoding device comprising a circuit, wherein
the circuit:
stores occupancy information of a child hierarchical node indicating whether or not the child hierarchical node is occupied; and
predicts occupancy information of a child node indicating whether or not the child node is occupied using the occupancy information of the child hierarchical node.

2. The point cloud decoding device according to claim 1, wherein
the circuit:
further stores occupancy information of a parent hierarchical node indicating whether or not the parent hierarchical node is occupied, and
predicts the occupancy information of the child node using the occupancy information of the child hierarchical node and the occupancy information of the parent hierarchical node.

3. The point cloud decoding device according to claim 1, wherein
the circuit predicts that the child node near which the child hierarchical node that is occupied exists is occupied.

4. The point cloud decoding device according to claim 1, wherein
the circuit predicts that the child node located between the child node predicted to be occupied and the parent hierarchical node that is occupied is occupied.

5. The point cloud decoding device according to claim 1, wherein
the circuit predicts that the child node is occupied when the child hierarchical node located on a path of a laser beam spaced away from a position of the child node by a scanning interval of a sensor is occupied.

6. The point cloud decoding device according to claim 1, wherein
the circuit estimate a position of the child hierarchical node including a point spaced away from a position of the child node by a scanning interval of a sensor, and predict that the child node is occupied when the child hierarchical node of which the position has been estimated is occupied.

7. The point cloud decoding device according to claim 1, wherein
when the intra prediction unit determines that a laser beam spaced away from a position of the child node by a scanning interval of a sensor passes through the inside of the child node, the circuit substitutes a laser beam passing through the inside of the child hierarchical node located near the child node for the laser beam spaced away from the position of the child node by a scanning interval of a sensor.

8. The point cloud decoding device according to claim 7, wherein
the circuit uses a lookup table calculated in advance for the determination and/or selection of the laser beam passing through the inside of the child hierarchical node located near the child node.

9. The point cloud decoding device according to claim 1, wherein
the circuit selects the child hierarchical node and/or the parent hierarchical node to be referred to depending on a distance from the child node.

10. The point cloud decoding device according to claim 1, wherein
the circuit selects the child hierarchical node and/or the parent hierarchical node to be referred to depending on a degree of improvement in compression performance in a case where a point cloud for training is encoded using intra prediction.

11. The point cloud decoding device according to claim 1, wherein
the circuit divides a scanning range of a sensor and store coordinates of the child hierarchical node located in each divided range.

12. A point cloud decoding method for decoding a point cloud from a bit stream, the point cloud decoding method comprising:
storing occupancy information of a child hierarchical node indicating whether or not the child hierarchical node is occupied; and
predicting occupancy information of a child node indicating whether or not the child node is occupied using the occupancy information of the child hierarchical node.

13. A program stored on a non-transitory computer-readable medium for causing a computer to function as a point cloud decoding device configured to decode a point cloud from a bit stream, the point cloud decoding device comprising a circuit, wherein
the circuit
stores occupancy information of a child hierarchical node indicating whether or not the child hierarchical node is occupied; and
predicts occupancy information of a child node indicating whether or not the child node is occupied using the occupancy information of the child hierarchical node.
